(19) United States
(12) Patent Application Publication
(10) Pub. No.: US 2006/0031893 A1
(43) Pub. Date: Feb. 9, 2006

(54) File path identification and display

(76) Inventors: Henry Y. Fang, Camas, WA (US); George Rome Borden IV, Vancouver, WA (US)

Correspondence Address: MARGER JOHNSON & MCCOLLOM, P.C., 210 SW MORRISON STREET, SUITE 400, PORTLAND, OR, 97204, US

(21) Appl. No.: 10/911,032

(22) Filed: Aug. 3, 2004

(51) Int. Cl. H04N 7/173; H04N 7/16; H04N 5/44

(52) U.S. Cl. 725/100; 725/131; 725/151; 348/725

(57) ABSTRACT

The invention relates to a television having an improved file path identification and display system and method. The improved file path identification and method maintains two sets of data strings that refer to the same operation objects. One set of strings is for the user interface display. The other set of strings is for system manipulation. In another words, operation strings might have different associated display string values and each operation string might have its corresponding display string stored in the system. The method might further dynamically assemble display strings into abbreviated or short hand form. The method, therefore, can maximize the display data.

### FIELD

This invention relates generally to a television system and method and, more particularly, to a television system and method with improved file path identification and display.

### BACKGROUND

Televisions have limited resource environments compared to personal computers. Additionally, television viewing distance is typically greater than personal computer viewing distance. These factors limit readable characters per television display line.

Advanced televisions might include applications that execute programmable code, for example Java. Some applications might transfer files stored in an external device or in memory cards. File transfer applications sometimes present long text strings identifying a file path, for example, a file path having in excess of 40 readable characters. Some televisions can not display the file path without truncation or other modification. A truncated or modified file path can frustrate proper identification of the file path.

Accordingly, a need remains for a system and method to improve file path identification and display.

### BRIEF DESCRIPTION OF THE DRAWINGS

The foregoing and other features and advantages of the invention(s) will become more readily apparent from the detailed description of embodiments that references the following drawings.

FIG. 1 is a block diagram of a television system embodiment that implements improved file path display.

FIG. 2A is a flowchart of a file path identification and display method according to an embodiment of the present invention.

FIG. 2B is a flowchart of a file path identification and display method according to an embodiment of the present invention.

FIG. 3 is a screen view of an abbreviated file path string display according to an embodiment of the present invention.

FIG. 4 is a screen view of a short hand file path string display according to an embodiment of the present invention.

FIG. 5 is a screen view of a left justified file path string display according to an embodiment of the present invention.

FIG. 6 is a screen view of a center justified file path string display according to an embodiment of the present invention.

FIG. 7 is a screen view of a right justified file path string display according to an embodiment of the present invention.

FIG. 8 is a screen view of a short hand form of the list box in a file transfer embodiment.

FIG. 9 is a screen view of an abbreviated form of the list box in a file transfer embodiment.

### DETAILED DESCRIPTION

For convenience, like numerals in the description refer to like structures in the drawings. The invention may provide a system and method for improved file path identification and display.

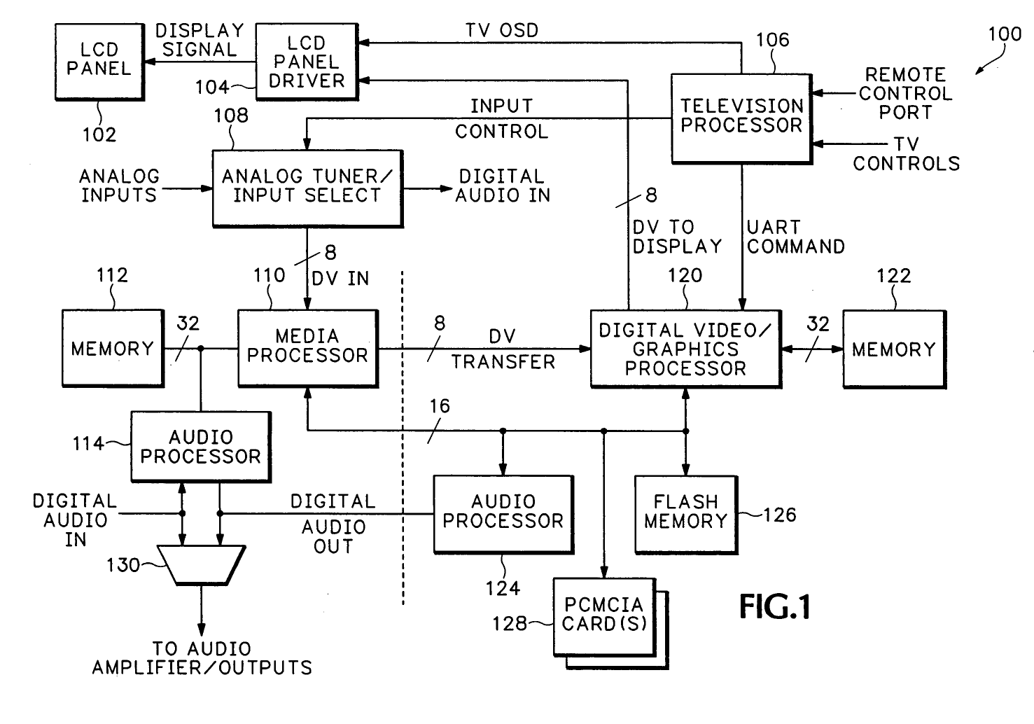

FIG. 1 is a block diagram of an embodiment television system that implements aspects of the present invention. A text file identification program to manage a text file path string display might be implemented in one or more of the blocks shown in FIG. 1.

Referring to FIG. 1, the television 100 includes a panel 102 having a fixed pixel structure, e.g., a liquid crystal display (LCD), plasma display, and the like. For simplicity, we refer to panel 102 as an LCD panel. Television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120. A person of reasonable skill in the art should recognize that the LCD panel driver 104 might accept a primary digital video signal in formats other than CCIR656 and still come within the scope of the present invention.

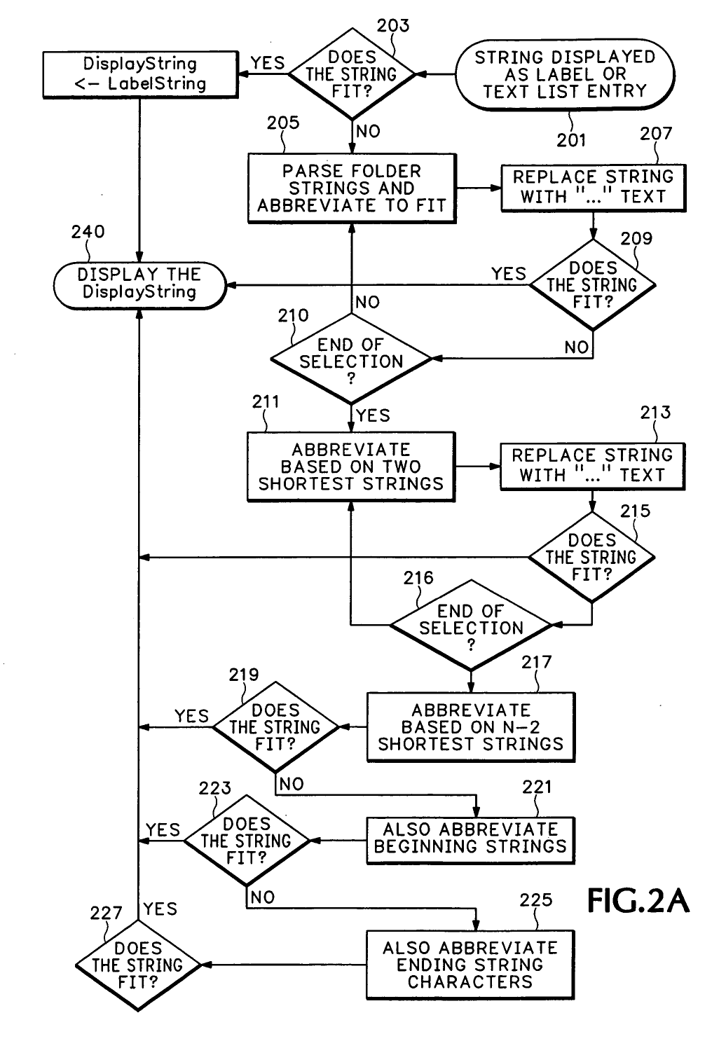

A television processor 106 provides basic control functions and viewer input interfaces for television 100. Television processor 106 receives viewer commands, both from buttons located on the television itself (TV controls) and from a handheld remote control (FIGS. 2-9) through the Remote Control Port. The Remote Control Port might accept input from the remote control in a variety of manners including infrared and radio waves as are well known in the art.

Based on the viewer commands, television processor 106 controls an analog tuner/input select section 108, and also supplies viewer inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or Red Green Blue (RGB) component video inputs, although various embodiments may not accept each of these signal types or may accept signals in other formats (such as PAL). The selected video input is converted to a digital data stream, DV In, in CCIR656 format (or other formats) and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 110 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code such as might be necessary to implement aspects of the alert manager, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

Display information may be processed to fit within a viewable area. Processing as it is used here involves adjusting display content. An example of processing involves eliminating characters to fit display information in a display area, for example within LCD panel 102 or within an area of LCD panel 102. Sometimes meaningful content is lost during this processing, for example, file path information may be processed to fit an area of a display 102, such as a display line, by truncating the file path information until it fits in the display line.

An embodiment may comprise a television 100 and a processor, for example television processor 106, coupled with the television 100, the processor 106 to process file path information and to display the processed file path information. An embodiment may therefore process file path information to fit a display area, such as a television display line, while conserving meaningful content in the displayed information.

An embodiment may comprise a processor 106 to process file path information and a display 102 coupled with the processor 106 to display processed file path information. Furthermore, an embodiment may comprise at least one storage device, such as memory 112, memory 122, flash memory 126, or any other storage medium, to store files and use file path information. In an embodiment the processor 106 can process file path information to fit on the display line. An embodiment may comprise an input to receive file path information from an external device. The processor 106 in the present embodiment may process file path information in multiple ways and display the file path information on the television 100. For example, the processor 106 may process file path information in at least one of a short hand file path string display and an abbreviated file path string display. Likewise, the processor 106 may process file path information for at least one of a left justified file path string display, a centered file path string display, and a right justified file path string display.

Generally, an embodiment may conserve content while displaying the content within a limited display area. Although embodiments of the invention are not limited to televisions or conventional display devices, these embodiments explain aspects of the invention.

FIG. 2A is a flowchart that summarizes a file path identification and display embodiment method of the present invention. In block 203, the method determines if a string fits in a predetermined display space, e.g., a single display line. If the string fits, the method displays the full display form of the text file string in block 240, if not, the string is parsed in block 205. An embodiment might parse the shortest portion of the string. An embodiment may parse only portions other than beginning and ending portions. The first portion of the string typically represents the drive name and the last portion of the string represents the file name. In block 207, the method replaces the parsed string with a filler, for example with three periods or “ . . . ”. The example embodiment uses a three period filler, however any filler may be used.

In block 209, the present embodiment determines if a single folder replacement allows for sufficient string display. If so, the string is displayed at block 240. Block 210 determines flow control on an end of selection operation. For example, the method may loop through block 205 to replace the next smallest portion or subfolder. The present embodiment does not require use of block 210 or other end of selection blocks.

Block 211 parses the two shortest portions of the string. The present embodiment excludes the beginning and ending portions from parsing in block 211. In block 213, the parsed portions are replaced with fillers, then the method determines if the string fits the display space in block 215. Similar to block 210 above, the method may loop through an end of selection block 216.

In block 217 the three shortest portions, not including beginning and ending portions, are parsed similar to blocks 205 and 211. In this regard the method may repeat and consider parsing of any and all subfolders. In block 219 the method may have considered all subfolders yet found insufficient display space. In this case, beginning portions may be parsed, as in block 221, or any portion may be parsed as in block 225. As shown, if any of the parsings and filler replacements allow the string to fit in the display space, then the method may display the string.

An embodiment may comprise measuring a string to be displayed in a predetermined display space and displaying the string if it can be displayed in the display space. The present embodiment may include replacing a portion of the string with code, or filler, and displaying the resultant string. The present embodiment may involve not replacing a first and last portion of the string. The present embodiment may include replacing two portions of the string with code and displaying the resultant string if replacing a single portion of the string with code does not allow the string to be displayed in the predetermined display space. The present embodiment may include replacing at least three portions of the string with code and displaying the resultant string, if replacing one less than the at least three portions of the string does not allow the string to be displayed in the predetermined display space. The present embodiment may include displaying the string on a single television display line. The present embodiment may include processing file path information in at least one of a short hand file path string display and an abbreviated file path string display. The present embodiment may include processing file path information for at least one of a left justified file path string display, a centered file path string display, and a right justified file path string display.

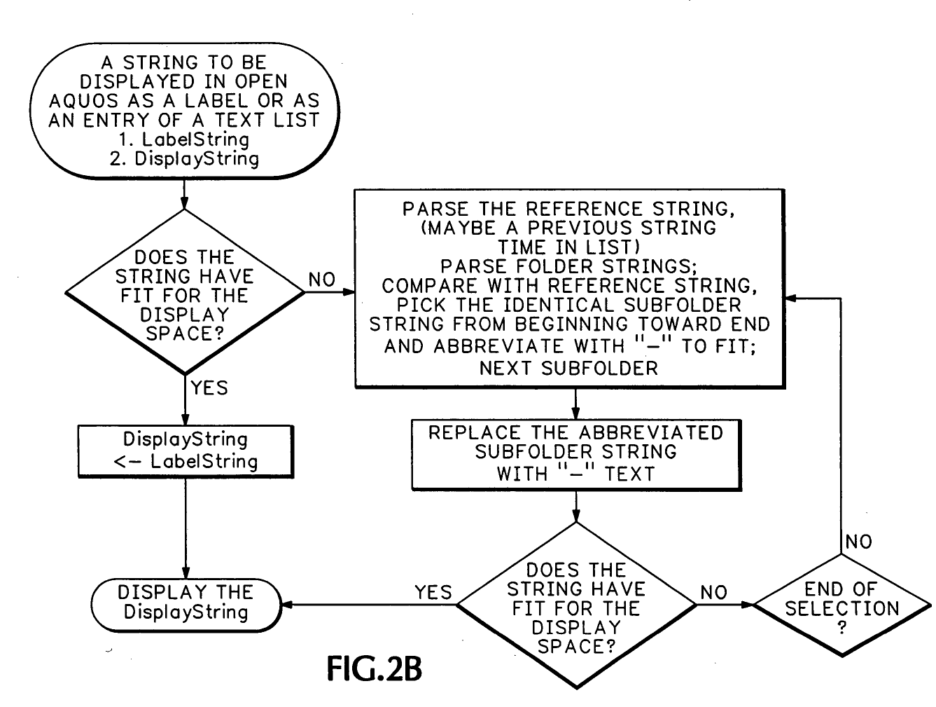

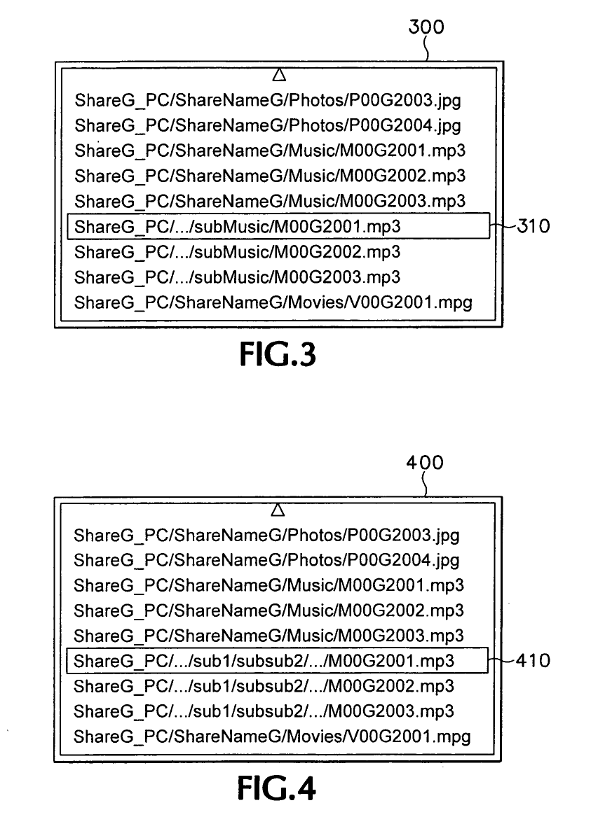

Embodiments may provide display algorithms to maximize or conserve display content. An exemplary embodiment contains three classes of display algorithms, full form display, abbreviated display form and short hand display form. FIG. 3 is a screen view of an abbreviated file path string display 300 according to an embodiment of the present invention. String 310 displays an abbreviated file path with the first subdirectory replaced with a filler, namely “ . . . ”. FIG. 4 is a screen view of a short hand file path string display 400 according to an embodiment of the present invention. String 410 displays a short-handed form file path with the first and fourth subdirectories replaced with a filler, namely “ . . . ”. An embodiment may dynamically assemble display strings into abbreviated or short hand form. The method, therefore, can maximize the value of the data presentation.

The full form display requires no truncation or modification in the text file path string.

The abbreviated display form 310 may be used when a text file path string exceeds the allowable characters per line. The method may replace intermediate file path portions with a filler, for instance with three periods or “ . . . ”, until the remaining file path string fits into the display. Embodiments are not limited to any specific filler, that is, any filler is sufficient so long as display information can fit in a display while conserving or maximizing content.

The short hand display form 410 may provide a filler in similar fashion to the abbreviated display form, however, the short hand display form 410 may replace predetermined or selected portions of the file path. The short hand display form 410 may fit a text file path string in a given display space, replace a minimum amount of text (for example, with the three periods), and maintain file hierarchy levels.

An embodiment may provide many screen views, which may be dynamically switchable and shown on a display 102. For example, a first screen view might display a list of text file path strings in a limited manner such as a general view of the text file path strings. A second screen view might provide more detailed information about a highlighted text file path string such as more detailed information on the highlighted text string. The first screen view may therefore be a convenient quick scan while the second screen view may be good for identification and confirmation. In an embodiment, the first and second screen views are available during file transfer application run time.

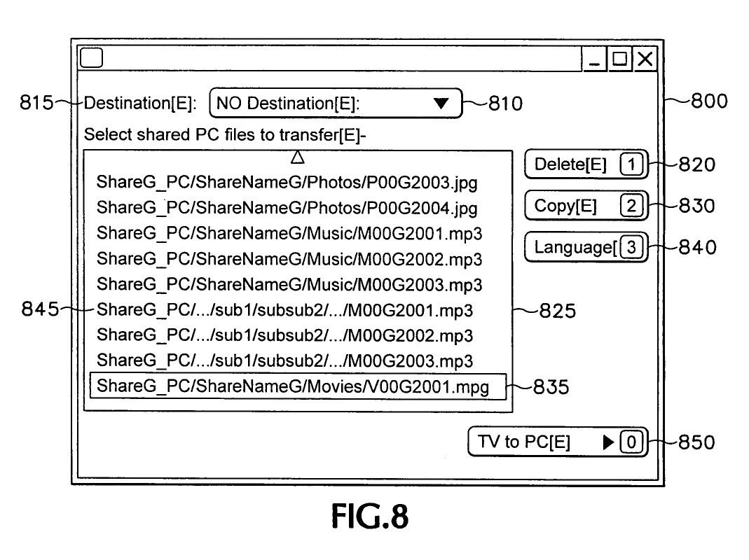

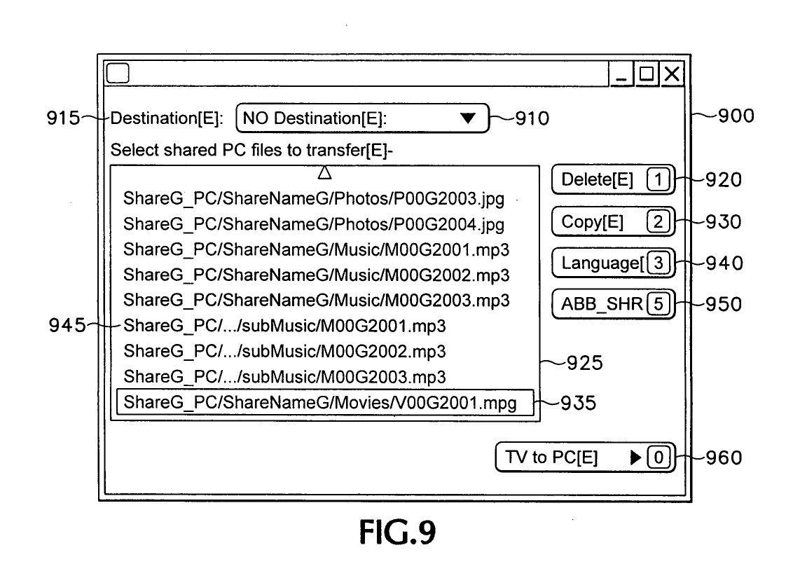

An embodiment might toggle between views, for example, abbreviated and short hand display forms. Toggling allows a user greater identification of listed files. FIG. 8 is a screen view 800 of a short hand form of a list box in a file transfer applet embodiment. FIG. 8 displays a destination 815 for a file transfer, a destination selection 810, delete 820, a copy 830 and language 840 options, and a transfer 850 option. FIG. 8 also displays a list box 825 of selected files with a specific file path 835 selected. FIG. 9 is a screen view of an abbreviated form of the list box in a file transfer applet embodiment. FIG. 9 displays a destination 915 for a file transfer, a destination selection 910, delete 920, a copy 930 and language 940 options, and a transfer 960 option. FIG. 9 also displays a list box 925 of selected files with a specific file path 935 selected. Referring to FIGS. 8 and 9, a method according to the present embodiment identifies file path 845, ShareG_PC/ .../sub1/subsub2/.../M00G2001.mp3 (Short-hand form), as file path 945, ShareG_PC/ .../subMusic/M00G2001.mp3 (Abbreviated form). Thus, the short hand form 845 conserves the file path name with few replacements in a different manner than the abbreviated form 945. For quick file browsing, the abbreviated display form 945 is more readable than the short hand display form 845. With the combination of the full, abbreviated, and short hand display forms, the user has a better understanding of the television's file structure.

An embodiment of the present invention may maintain two sets of data strings that refer to the same operation objects. For example, one set of strings may be for a user interface display while another set of strings may be for system manipulation. Put differently, operation strings might have different associated display string values and each operation string might have a corresponding display string stored in the system. In general, numerous implementations may parse and replace, or even just selectively parse to fit information in a display space while conserving content, for example, parsing file path information to conserve useful information while fitting the file path information in a display space.

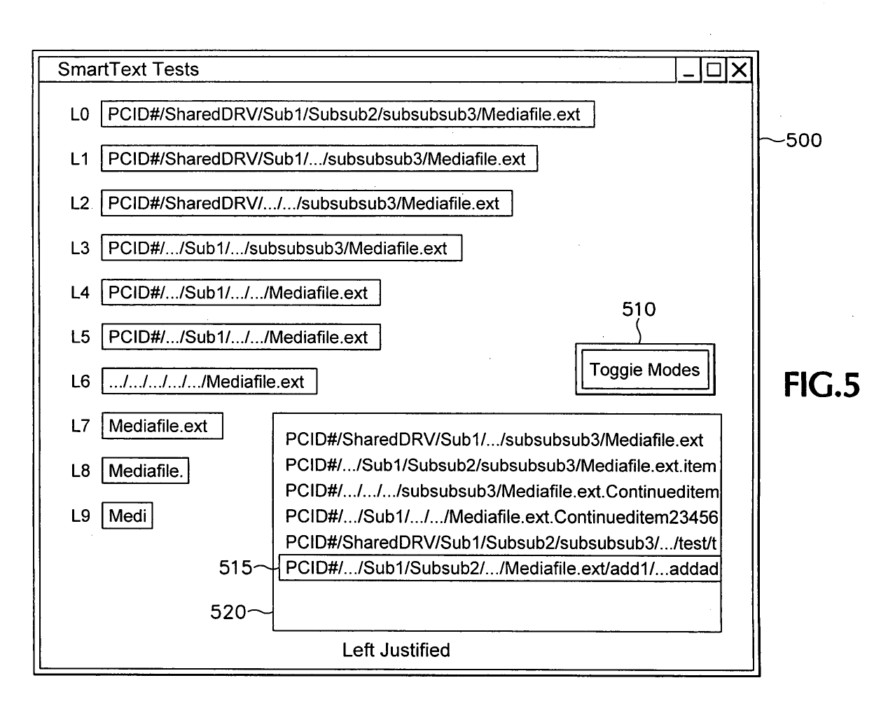

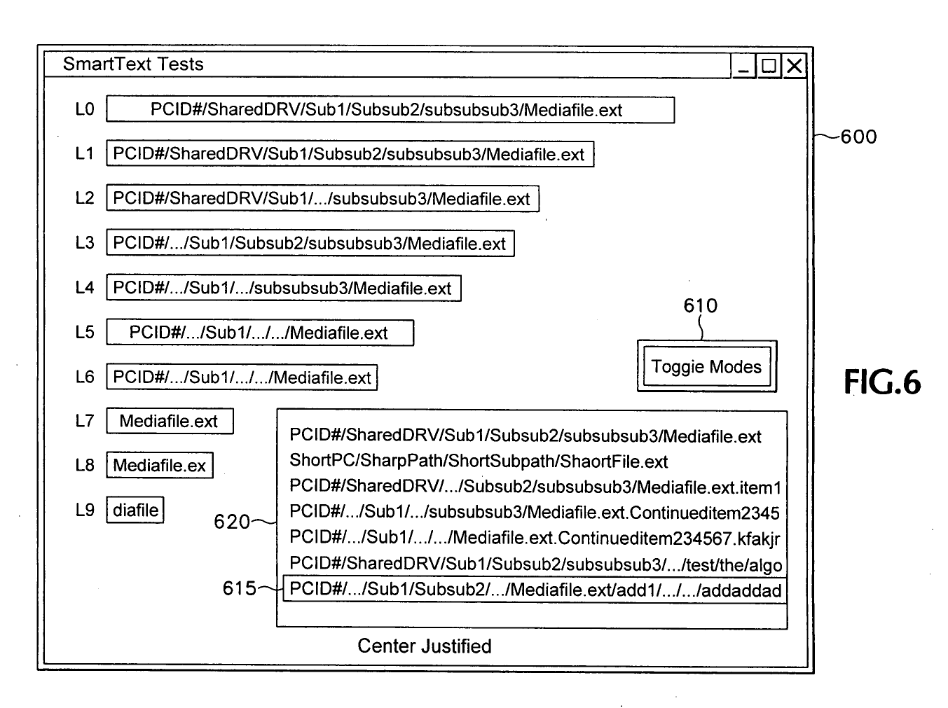

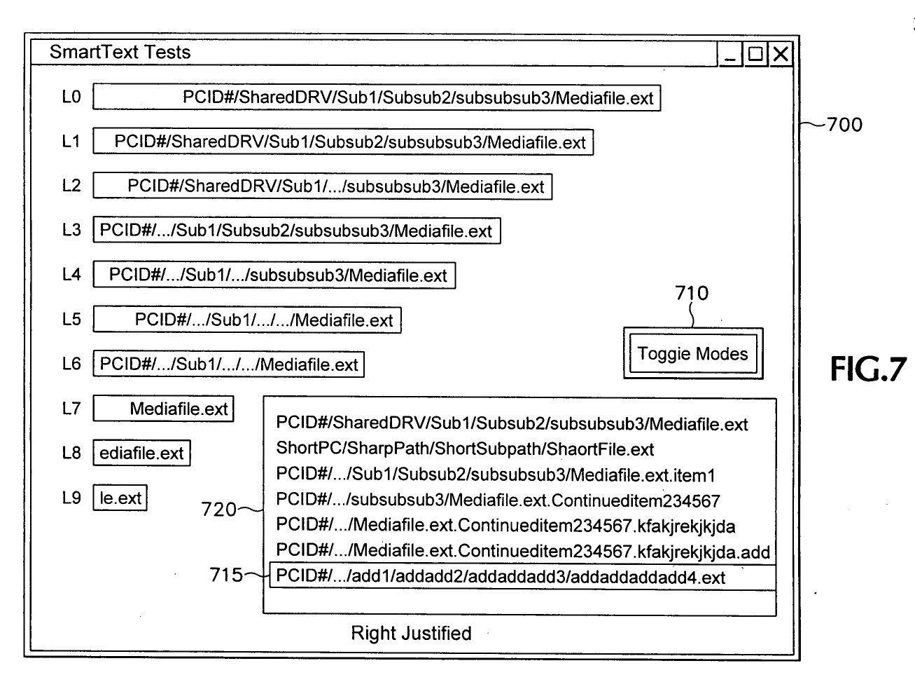

The method may use left, center, and right justification to show the left, center, and right most portions, respectively, of the filenames in the predetermined display space. Embodiments may adjust display 102 characteristics in additional ways. FIG. 5 illustrates a screen view 500 of an embodiment with a left justified file path string display. File paths L0 through L9 represent different file path representations in short-hand, abbreviated, or full forms. An embodiment may comprise a toggle modes button 510 to toggle between left justified, right justified and centered displays or also between abbreviated, short-hand or full form screen displays. An embodiment may have selectable strings 515 in a viewable area 520. Various parts of the text can be viewed in left, center, and right justified modes. FIGS. 6 and 7 display the center or right justified text edge.

Referring to FIG. 5, an embodiment places a fixed text string in various display lengths to fit in different display spaces. For example, the line L0 includes sufficient space, e.g., 620 pixels, to display the entirety of a text string. The embodiment, therefore, uses full display form to display the text string path. In the line L1, the embodiment replaced the subdirectory subsub2 with three periods or “ . . . ” because the display space, e.g., 500 pixels, was insufficient to display the entire file path. In the line L2, the embodiment replaced the subdirectory sub1 and subsub2 with three periods or “ . . . ” because the display space, e.g., 480 pixels, was insufficient to display the entire path. In the line L3, the embodiment replaced the SharedDRV and the subdirectory subsub2 with three periods or “ . . . ” because the display space, e.g., 450 pixels, was insufficient to display the entire path. In the line L4, embodiment replaced the SharedDRV and the subdirectories subsub2 and subsubsub3 with three periods or “ . . . ” because the display space, e.g., 400 pixels, was insufficient to display the entire path. In the line L5, embodiment replaced the SharedDRV and the subdirectories subsub2 and subsubsub3 with three periods or “ . . . ” because the display space, e.g., 350 pixels, was insufficient to display the entire path. In the line L6, the embodiment replaced the PCID# and other string portions with three periods or “ . . . ” because the display space, e.g., 300 pixels, was insufficient to display the entire path. In the lines L7, L8, and L9 only a filename is displayed within a 150, 100, and 50 pixel space.

An embodiment might be applied to file transfer applications running on a television 100, additionally, applications running on other displays are within the scope of the present invention. Furthermore, an embodiment may be useful in media file presentation applications executing Java code. In an embodiment users can view the items in the list, select files in multiple display formats, and manipulate, e.g., by deleting, copying, playing, and the like, selected files in the list component.

Having illustrated and described the principles of our invention(s), it should be readily apparent to those skilled in the art that the invention(s) can be modified in arrangement and detail without departing from such principles. We claim all modifications coming within the spirit and scope of the accompanying claims.

We claim the following:

1. A system comprising:
a television; and
a processor coupled with the television, the processor to process file path information and to display the processed file path information.

2. The system of claim 1, where the processor can process the file path information to fit on a television display line.

3. The system of claim 1 comprising at least one storage device, the storage device to store files and use file path information.

4. The system of claim 1
where the processor can process the file path information in multiple ways; and
where the television can display file path information.

5. The system of claim 4 where the processor can process file path information in at least one of a short hand file path string display and an abbreviated file path string display.

6. The system of claim 4 where the processor can process file path information for at least one of a left justified file path string display, a centered file path string display, and a right justified file path string display.

7. A television comprising:
a processor to process file path information; and
a display coupled with the processor, to display processed file path information.

8. The television of claim 7, where the processor can process file path information to fit on a television display line.

9. The television of claim 7 comprising an input, the input to receive file path information from an external device.

10. The television of claim 7
where the processor can process file path information in multiple ways; and
where the television can display the file path information.

11. The television of claim 10, where the processor can process file path information in at least one of a short hand file path string display and an abbreviated file path string display.

12. The television of claim 11, where the processor can process file path information for at least one of a left justified file path string display, a centered file path string display, and a right justified file path string display.

13. A method comprising:
measuring if a string can be displayed in a predetermined display space; and
displaying the string if it can be displayed in the display space.

14. The method of claim 13 comprising:
replacing a portion of the string with code; and
displaying the resultant string.

15. The method of claim 14 comprising, not replacing a first and last portion of the string.

16. The method of claim 13 comprising:
replacing two portions of the string with code; and
displaying the resultant string, if replacing a single portion of the string with code does not allow the string to be displayed in the predetermined display space.

17. The method of claim 13 comprising:
replacing at least three portions of the string with code; and
displaying the resultant string, if replacing one less than the at least three portions of the string does not allow the string to be displayed in the predetermined display space.

18. The method of claim 13 where displaying includes displaying the string on a single television display line.

19. The method of claim 13 comprising processing file path information in at least one of a short hand file path string display and an abbreviated file path string display.

20. The method of claim 13 comprising processing file path information for at least one of a left justified file path string display, a centered file path string display, and a right justified file path string display.
